(19) United States
(12) Patent Application Publication
(10) Pub. No.: US 2010/0277523 A1
(43) Pub. Date: Nov. 4, 2010

(54) Liquid Ejection Apparatus And Head Maintenance Method

(76) Inventor: Baku Nishikawa, Ashigarakami-gun (JP)

Correspondence Address: FISH & RICHARDSON P.C., PO BOX 1022, MINNEAPOLIS, MN, 55440-1022, US

(21) Appl. No.: 12/727,017

(22) Filed: Mar. 18, 2010

(30) Foreign Application Priority Data
Mar. 19, 2009 (JP) 2009068554

(51) Int. Cl. B41J 29/38; B41J 2/165; B41J 2/145

(52) U.S. Cl. 347/9; 347/29; 347/40

(57) ABSTRACT

A liquid ejection apparatus includes: an inkjet head including a plurality of nozzles which eject liquid containing a water-soluble high-boiling-point organic solvent having an SP value of 30 or lower at a concentration of 10 weight percent or higher and 25 weight percent or lower, a plurality of liquid chambers connected to the plurality of nozzles respectively, and a plurality of supply flow channels to any of which each of the plurality of nozzles is connected and which supply the liquid to the plurality of nozzles via the plurality of liquid chambers; a capping device configured to simultaneously cap the nozzles connected to the same supply flow channel, from a liquid ejection surface side of the inkjet head; a pressure application device which applies pressure to the liquid inside the nozzles via the capping device; and a pressure control device which controls the pressure application device so as to repeat pressurization and depressurization with respect to the liquid inside the nozzles.

### BACKGROUND OF THE INVENTION

1. Field of the Invention

The present invention relates to a liquid ejection apparatus and a head maintenance method, and more particularly to maintenance technology for a liquid ejection surface of an inkjet head.

2. Description of the Related Art

As a general image recording apparatus, it is suitable to use an inkjet recording apparatus, which forms a desired image on a recording medium by ejecting and depositing colored inks from a plurality of nozzles provided in an inkjet head.

It is known that in an inkjet recording apparatus which forms an image or a prescribed pattern on a recording medium by ejecting a functional material, such as ink, by means of an inkjet head, if blocking of foreign matter or infiltration of air bubbles occurs inside the nozzles of the inkjet head, then ejection abnormalities such as ejection failures or deviation of the ejection direction, and the like, arise. In particular, if a liquid which generates an aggregated material upon drying, such as an ink containing a high-boiling-point organic solvent having a low SP value, is used, then it is difficult to remove the aggregated material (solidified material) produced inside the nozzles and there is an increased possibility of ejection abnormalities occurring due to the aggregated material produced inside the nozzles. In order to avoid the occurrence of ejection abnormality nozzles in an inkjet recording apparatus, maintenance processing is carried out periodically on the inkjet head.

Japanese Patent Application Publication No. 2004-291385 discloses a liquid spraying apparatus in which, when an increased viscosity restoration mode is selected, a nozzle surface is sealed with a cap member, ink liquid sucked out from the recording head is collected inside the sealed space of the cap member, and by alternately repeating operations of pressurization and depressurization in this state, liquid is moved between the interior of the sealed space and the recording head, thereby promoting the dispersion and redissolution of the liquid of increased viscosity in the recording head.

Japanese Patent Application Publication No. 2-525 discloses an inkjet recording apparatus which comprises a partial cap device that covers a portion of a plurality of ejection ports and is composed so as to suction ink from a portion of the ejection ports via the partial cap.

However, in the liquid spraying apparatus described in Japanese Patent Application Publication No. 2004-291385, the pressurization and depressurization operations carried out with the nozzle surface sealed by the cap member apply pressure simultaneously to all of the nozzles, and therefore the pressure escapes from the normal nozzles, thus reducing the pressure applied to the nozzles from which it is wished to remove material of increased viscosity. In particular, there has recently been a tendency toward increasing numbers of nozzles in inkjet heads, and therefore problems of this kind have become manifest.

In a composition which applies pressure in one direction only, as in the inkjet recording apparatus described in Japanese Patent Application Publication No. 2-525, it is extremely difficult to remove ink which has formed a film on the inner surface of the nozzles, or solidified material inside the nozzles, thus giving rise to increase in the number of maintenance operations and also causing increased size of the apparatus due to increase in the applied pressure.

More specifically, in an inkjet head having a large number of nozzles, especially if using ink which dries or solidifies, it is very difficult indeed to remove solidified material inside the nozzles or air which has entered inside the nozzles, and these problems remain unresolved.

### SUMMARY OF THE INVENTION

The present invention has been contrived in view of these circumstances, an object thereof being to provide a liquid ejection apparatus and a head maintenance method whereby it is possible efficiently to remove solidified material inside nozzles and air which has entered inside the nozzles, of an inkjet head having a plurality of nozzles.

In order to attain an object described above, one aspect of the present invention is directed to a liquid ejection apparatus comprising: an inkjet head including: a plurality of nozzles which eject liquid containing a water-soluble high-boiling-point organic solvent having an SP value of 30 or lower at a concentration of 10 weight percent or higher and 25 weight percent or lower, a plurality of liquid chambers connected to the plurality of nozzles respectively, and a plurality of supply flow channels to any of which each of the plurality of nozzles is connected and which supply the liquid to the plurality of nozzles via the plurality of liquid chambers; a capping device configured to simultaneously cap the nozzles connected to the same supply flow channel, from a liquid ejection surface side of the inkjet head; a pressure application device which applies pressure to the liquid inside the nozzles via the capping device; and a pressure control device which controls the pressure application device so as to repeat pressurization and depressurization with respect to the liquid inside the nozzles.

The SP value (solubility parameter) of the water-soluble solvent described here is a value expressed as the square root of the molecular aggregation energy, and is indicated in the unit of (MPa)^{1/2} and the value at 25° C.

In order to attain an object described above, another aspect of the present invention is directed to a head maintenance method for an inkjet head includes a plurality of nozzles which eject liquid containing a water-soluble high-boiling-point organic solvent having an SP value of 30 or lower at a concentration of 10 weight percent or higher and 25 weight percent or lower, a plurality of liquid chambers connected to the plurality of nozzles respectively, and a plurality of supply flow channels which supply the liquid to the plurality of nozzles via the plurality of liquid chambers and to any of which each of the plurality of nozzles is connected, the head maintenance method comprising: a capping step of simultaneously capping the nozzles connected to the same supply flow channel from a liquid ejection surface side of the inkjet head; and a pressurization and depressurization step of repeating pressurization and depressurization of the liquid inside the nozzles via a capping device.

According to the present invention, since the nozzles which are capped simultaneously by the capping device are limited to nozzles which receive supply of liquid from the same supply flow channel, then it is possible to prevent dispersion of the pressure applied when in the capped state and therefore maintenance efficiency can be improved.

### BRIEF DESCRIPTION OF THE DRAWINGS

FIG. 1 is a general schematic drawing of an inkjet image recording apparatus according to an embodiment of the present invention;

FIG. 2 is a plan view perspective diagram showing an embodiment of the inkjet head in FIG. 1;

FIG. 3 is a cross-sectional diagram showing the inner composition of an ink chamber unit;

FIG. 4 is a general schematic drawing of a maintenance processing unit in the inkjet recording apparatus shown in FIG. 1;

FIG. 5 is a general schematic drawing showing a further mode of the maintenance processing unit shown in FIG. 4;

FIGS. 6A to 6C are diagrams showing maintenance processing performed by the maintenance processing unit shown in FIG. 4;

FIG. 7 is a flowchart of maintenance processing employed in an embodiment of the invention;

FIG. 8 is a principal block diagram showing the system configuration of the inkjet recording apparatus shown in FIG. 1;

FIG. 9 is a diagram showing one example of a capping region;

FIG. 10 is a perspective diagram showing a state where the capping region shown in FIG. 9 is capped;

FIG. 11 is a diagram showing a further example of the capping region shown in FIG. 9;

FIG. 12 is a diagram showing a further example of the capping region shown in FIG. 9 and FIG. 10;

FIG. 13 is a partial enlarged view of FIG. 12;

FIG. 14 is a block diagram showing the composition of a maintenance processing unit relating to a first application example;

FIG. 15 is a diagram showing the structure of a head relating to a second application example; and

FIG. 16 is a partial enlarged view of FIG. 15.

### DETAILED DESCRIPTION OF THE PREFERRED EMBODIMENTS

### Entire Configuration of Inkjet Recording Apparatus

First, an inkjet recording apparatus will be described as an example of an image forming apparatus according to an embodiment of the present invention.

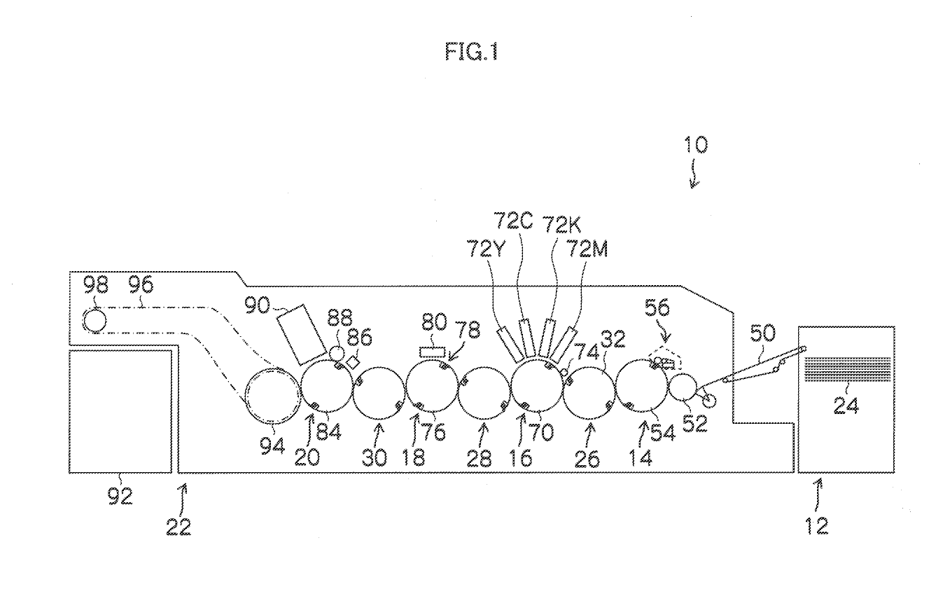

FIG. 1 is a structural diagram illustrating the entire configuration of an inkjet recording apparatus 10 according to an embodiment of the present invention. The inkjet recording apparatus 10 shown in the drawing is a recording apparatus in a two-liquid aggregating system of forming an image on a recording surface of a recording medium 24 by using ink (an aqueous ink) and a treatment liquid (aggregation treatment liquid). The inkjet recording apparatus 10 includes a paper feed unit 12, a treatment liquid application unit 14, an image formation unit 16, a drying unit 18, a fixing unit 20, and a discharge unit 22 as the main components. A recording medium 24 (paper sheets) is stacked in the paper feed unit 12, and the recording medium 24 is fed from the paper feed unit 12 to the treatment liquid application unit 14. A treatment liquid is applied to the recording surface in the treatment liquid application unit 14, and then a color ink is applied to the recording surface in the image formation unit 16. The image is fixed with the fixing unit 20 on the recording medium 24 onto which the ink has been applied, and then the recording medium is discharged with the discharge unit 22.

In the inkjet recording apparatus 10, intermediate conveyance units 26, 28 and 30 are provided between the units, and the recording medium 24 is transferred by these intermediate conveyance units 26, 28 and 30. Thus, a first intermediate conveyance unit 26 is provided between the treatment liquid application unit 14 and image formation unit 16, and the recording medium 24 is transferred from the treatment liquid application unit 14 to the image formation unit 16 by the first intermediate conveyance unit 26. Likewise, the second intermediate conveyance unit 28 is provided between the image formation unit 16 and the drying unit 18, and the recording medium 24 is transferred from the image formation unit 16 to the drying unit 18 by the second intermediate conveyance unit 28. Further, a third intermediate conveyance unit 30 is provided between the drying unit 18 and the fixing unit 20, and the recording medium 24 is transferred from the drying unit 18 to the fixing unit 20 by the third intermediate conveyance unit 30.

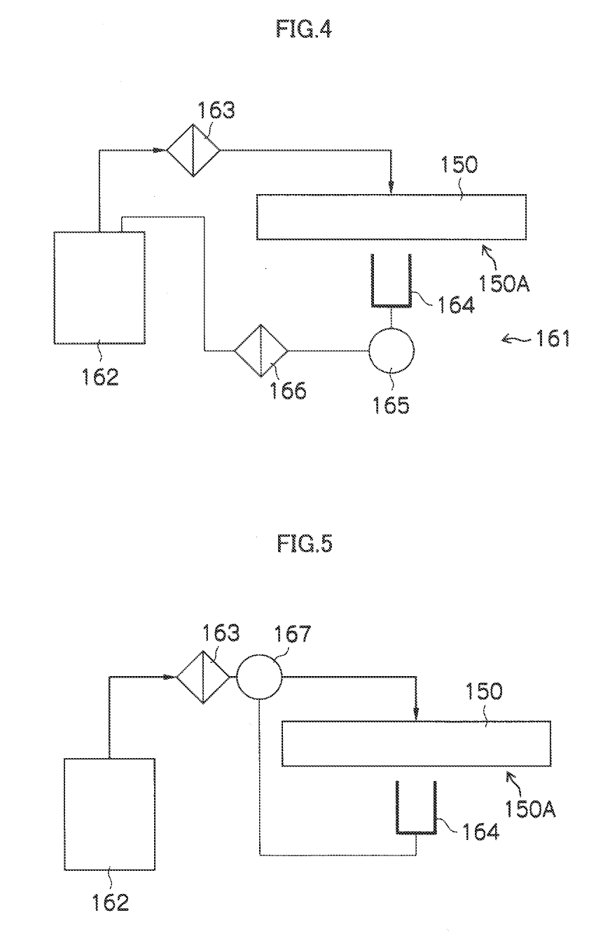

Although not shown in FIG. 1, the inkjet recording apparatus 10 described in the present embodiment comprises a maintenance processing apparatus (indicated by the reference numeral 161 in FIG. 4) which performs maintenance of the inkjet heads 72M, 72K, 72C and 72Y provided in the image formation unit 16.

Each unit (paper feed unit 12, treatment liquid application unit 14, image formation unit 16, drying unit 18, fixing unit 20, and discharge unit 22) of the inkjet recording apparatus 10 will be described below in greater details.

### Paper Feed Unit

The paper feed unit 12 feeds the recording medium 24 to the image formation unit 16. A paper feed tray 50 is provided in the paper feed unit 12, and the recording medium 24 is fed, sheet by sheet, from the paper feed tray 50 to the treatment liquid application unit 14.

### Treatment Liquid Application Unit

The treatment liquid application unit 14 is a mechanism that applies a treatment liquid to the recording surface of the recording medium 24. The treatment liquid includes a coloring material aggregating agent that causes the aggregation of a coloring material (pigment) included in the ink applied in the image formation unit 16, and the separation of the coloring material and a solvent in the ink is enhanced when the treatment liquid is brought into contact with the ink.

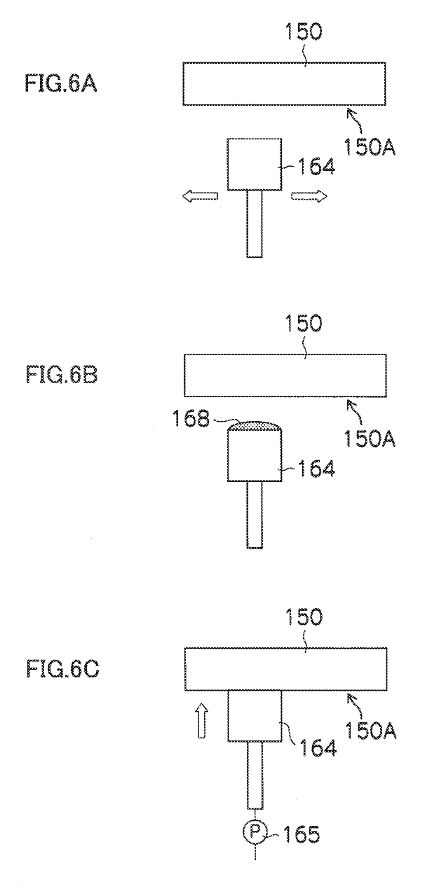

As shown in FIG. 1, the treatment liquid application unit 14 includes a paper transfer drum 52, a treatment liquid drum 54, and a treatment liquid application device 56. The paper transfer drum 52 is disposed between the paper feed tray 50 of the paper feed unit 12 and the treatment liquid drum 54. The rotation of the paper transfer drum 52 is driven and controlled by a below-described motor driver 176 (see FIGS. 6A-6C). The recording medium 24 fed from the paper feed unit 12 is received by the paper transfer drum 52 and transferred to the treatment liquid drum 54. The below-described intermediate conveyance unit may be also provided instead of the paper transfer drum 52.

The treatment liquid drum 54 is a drum that holds and rotationally conveys the recording medium 24. The rotation of the treatment liquid drum 54 is driven and controlled by the below-described motor driver 176 (see FIGS. 6A-6C). Further, the treatment liquid drum 54 is provided on the outer circumferential surface thereof with a hook-shaped holding device, by which the leading end of the recording medium 24 can be held. In a state in which the leading end of the recording medium 24 is held by the holding device, the treatment liquid drum 54 is rotated to rotationally convey the recording medium 24. In this case, the recording medium 24 is conveyed in a state where the recording surface thereof faces outward. The treatment liquid drum 54 may be provided with suction apertures on the outer circumferential surface thereof and connected to a suction device that performs suction from the suction apertures. As a result, the recording medium 24 can be held in a state of tight adherence to the outer circumferential surface of the treatment liquid drum 54.

The treatment liquid application device 56 is provided on the outside of the treatment liquid drum 54 opposite the outer circumferential surface thereof. The treatment liquid application device 56 applies the treatment liquid onto the recording surface of the recording medium 24. The treatment liquid application device 56 includes: a treatment liquid container, in which the treatment liquid to be applied is held; an anilox roller, a part of which is immersed in the treatment liquid held in the treatment liquid container; and a rubber roller, which is pressed against the anilox roller and the recording medium 24 that is held by the treatment liquid drum 54, so as to transfer the treatment liquid metered by the anilox roller 64 to the recording medium 24. With the treatment liquid application device 56 of the above-described configuration, the treatment liquid is applied onto the recording medium 24, while being metered. In this case, it is preferred that the film thickness of the treatment liquid be sufficiently smaller than the diameter of ink droplets that are ejected from inkjet heads 72M, 72K, 72C and 72Y of the image formation unit 16. For example, when the ink droplet volume is 2 picoliters (pl), the average diameter of the droplet is 15.6 μm. In this case, when the film thickness of the treatment liquid is large, the ink dot will be suspended in the treatment liquid, without coming into contact with the surface of the recording medium 24. Accordingly, when the ink droplet volume is 2 pl, it is preferred that the film thickness of the treatment liquid be not more than 3 μm in order to obtain a landing dot diameter not less than 30 μm.

In the present embodiment, an example is described where a roller-based application method is employed as a method of applying treatment liquid to the recording surface of the recording medium 24, but the method is not limited to this, and it is possible to employ various other methods, such as a spray method, an inkjet method, or the like. Furthermore, in an image forming method which fixes ink droplets that have been ejected onto a recording medium from the inkjet heads 72M, 72K, 72C and 72Y of the image formation unit 16, by applying energy to the ink through heating, pressurization, irradiation of radiation, or the like, the treatment liquid deposition unit 14 is omitted.

### Image Formation Unit

The image formation unit 16 is a mechanism which prints an image corresponding to an input image by ejecting and depositing droplets of ink by an inkjet method, and the image formation unit 16 includes an image formation drum 70, a paper pressing roller 74 and the inkjet heads 72M, 72K, 72C and 72Y. The inkjet heads 72M, 72K, 72C and 72Y correspond to inks of four colors: magenta (M), black (K), cyan (C) and yellow (Y), and are disposed in the order of description from the upstream side in the rotation direction of the image formation drum 70.

The image formation drum 70 is a drum that holds the recording medium 24 on the outer circumferential surface thereof and rotationally conveys the recording medium 24. The rotation of the image formation drum 70 is driven and controlled by the below-described motor driver 176 (see FIGS. 6A-6C). Further, the image formation drum 70 is provided on the outer circumferential surface thereof with a hook-shaped holding device, by which the leading end of the recording medium 24 can be held. In a state in which the leading end of the recording medium 24 is held by the holding device, the image formation drum 70 is rotated to rotationally convey the recording medium 24. In this case, the recording medium 24 is conveyed in a state where the recording surface thereof faces outward, and inks are deposited on the recording surface by the inkjet heads 72M, 72K, 72C and 72Y.

The paper pressing roller 74 is a guide member for causing the recording medium 24 to tightly adhere to the outer circumferential surface of the image formation drum 70, and is arranged so as to face the outer circumferential surface of the image formation drum 70. More specifically, the paper pressing roller 74 is disposed to the downstream side of the position where transfer of the recording medium 24 is received, and to the upstream side from the inkjet heads 72M, 72K, 72C and 72Y, in terms of the direction of conveyance of the recording medium 24 (the direction of rotation of the image formation drum 70).

When the recording medium 24 that has been transferred onto the image formation drum 70 from the intermediate conveyance unit 26 is rotationally conveyed in a state where the leading end portion of the recording medium 24 is held by the holding device, the recording medium 24 is pressed by the paper pressing roller 74 to tightly adhere to the outer circumferential surface of the image formation drum 70. When the recording medium 24 has been made to tightly adhere to the outer circumferential surface of the image formation drum 70 in this way, the recording medium 24 is conveyed to a print region directly below the inkjet heads 72M, 72K, 72C and 72Y in a state where the recording medium 24 does not float up at all from the outer circumferential surface of the image formation drum 70.

The inkjet heads 72M, 72K, 72C and 72Y are recording heads (inkjet heads) of the inkjet system of the full line type that have a length corresponding to the maximum width of the image formation region in the recording medium 24. A nozzle row is formed on the ink ejection surface of the inkjet head. The nozzle row has a plurality of nozzles arranged therein for discharging ink over the entire width of the image recording region. Each of the inkjet heads 72M, 72K, 72C and 72Y is fixedly disposed so as to extend in the direction perpendicular to the conveyance direction (rotation direction of the image formation drum 70) of the recording medium 24.

Furthermore, each of the inkjet heads 72M, 72K, 72C and 72Y is disposed at an inclination with respect to the horizontal, in such a manner that each of the nozzle surfaces of the inkjet heads 72M, 72K, 72C and 72Y is substantially parallel to the recording surface of the recording medium 24 held on the outer circumferential surface of the image formation drum 70.

Droplets of corresponding colored inks are ejected from the inkjet heads 72M, 72K, 72C and 72Y having the above-described configuration toward the recording surface of the recording medium 24 held on the outer circumferential surface of the image formation drum 70. As a result, the ink comes into contact with the treatment liquid that has been heretofore applied on the recording surface by the treatment liquid application unit 14, the coloring material (pigment) dispersed in the ink is aggregated, and a coloring material aggregate is formed. Therefore, the coloring material flow on the recording medium 24 is prevented and an image is formed on the recording surface of the recording medium 24. In this case, because the image formation drum 70 of the image formation unit 16 is structurally separated from the treatment liquid drum 54 of the treatment liquid application unit 14, the treatment liquid does not adhere to the inkjet heads 72M, 72K, 72C and 72Y, and the number of factors preventing the ejection of ink can be reduced.

In the present embodiment, the CMYK standard color (four colors) configuration is described, but combinations of ink colors and numbers of colors are not limited to that of the present embodiment, and if necessary, light inks, dark inks, and special color inks may be added. For example, a configuration is possible in which inkjet heads are added that eject light inks such as light cyan and light magenta. The arrangement order of color heads is also not limited.

### Drying Unit

The drying unit 18 dries water included in the solvent separated by the coloring material aggregation action. As shown in FIG. 1, the drying unit includes a drying drum 76 and a solvent dryer 78.

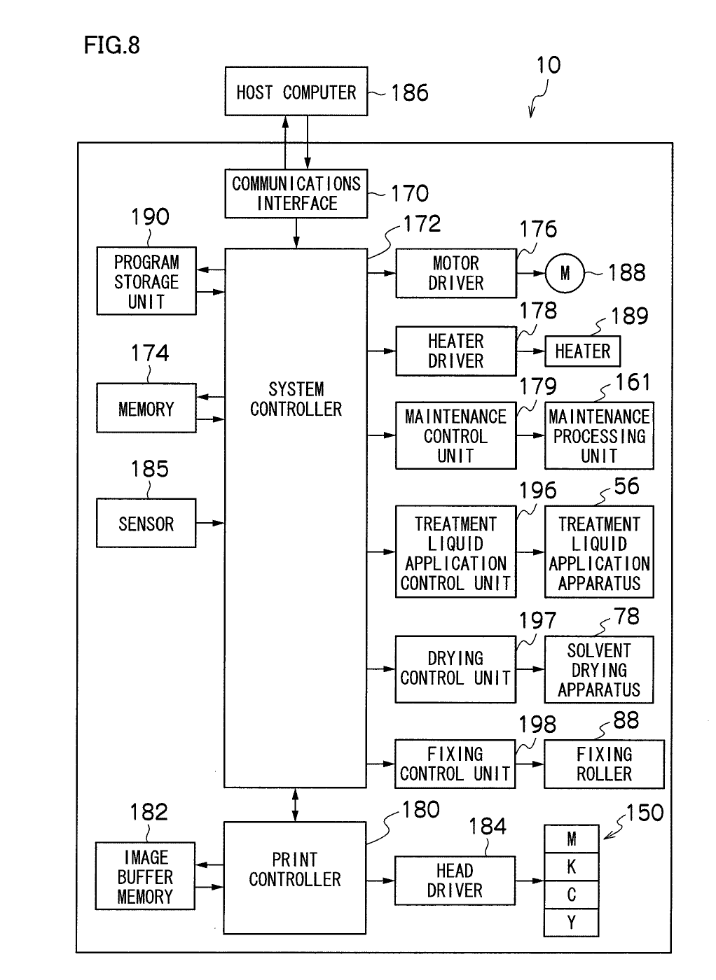

The drying drum 76 is a drum that holds the recording medium 24 on the outer circumferential surface thereof and rotationally conveys the recording medium 24. The rotation of the drying drum 76 is driven and controlled by the below-described motor driver 176 (see FIG. 8). Further, the drying drum 76 is provided on the outer circumferential surface thereof with a hook-shaped holding device, by which the leading end of the recording medium 24 can be held. In a state in which the leading end of the recording medium 24 is held by the holding device, the drying drum 76 is rotated to rotationally convey the recording medium. In this case, the recording medium 24 is conveyed in a state where the recording surface thereof faces outward. The drying treatment is carried out by the solvent dryer 78 with respect to the recording surface of the recording medium 24. The drying drum 76 may be provided with suction apertures on the outer circumferential surface thereof and connected to a suction device that performs suction from the suction apertures. As a result, the recording medium 24 can be held in a state of tight adherence to the outer circumferential surface of the drying drum 76.

The solvent dryer 78 is disposed in a position facing the outer circumferential surface of the drying drum 76, and includes a halogen heater 80. The halogen heater 80 is controlled to blow warm air at a prescribed temperature (for example, 50° C. to 70° C.) at a constant blowing rate (for example, 12 m³/min) toward the recording medium 24.

With the solvent dryer 78 of the above-described configuration, water included in the ink solvent on the recording surface of the recording medium 24 held by the drying drum 76 is evaporated, and drying treatment is performed. In this case, because the drying drum 76 of the drying unit 18 is structurally separated from the image formation drum 70 of the image formation unit 16, the number of ink non-ejection events caused by drying of the head meniscus portion by thermal drying can be reduced in the inkjet heads 72M, 72K, 72C and 72Y. Further, there is a degree of freedom in setting the temperature of the drying unit 18, and the optimum drying temperature can be set.

It is desirable that the curvature of the drying drum 76 is in the range of not less than 0.002 (1/mm) and not more than 0.0033 (1/mm) If the curvature of the drying drum 76 is less than 0.002 (1/mm), then even if the recording medium 24 is made to curve, an insufficient effect in correcting cockling of the recording medium 24 is obtained, and if the curvature exceeds 0.0033 (1/mm), then the recording medium 24 is curved more than necessary and does not return to its original shape, but rather is output to the stack in a curved state.

Furthermore, it is desirable that the surface temperature of the drying drum 76 is set to 50° C. or above. By heating from the rear surface of the recording medium 24, drying is promoted and breaking of the image during fixing can be prevented. In this case, more beneficial effects are obtained if a device for causing the recording medium 24 to tightly adhere to the outer circumferential surface of the drying drum 76 is provided. As a device for causing the recording medium 24 to tightly adhere in this way, it is possible to employ various methods, such as vacuum suction, electrostatic attraction, or the like.

There are no particular restrictions on the upper limit of the surface temperature of the drying drum 76, but from the viewpoint of the safety of maintenance operations such as cleaning the ink adhering to the surface of the drying drum 76 (namely, preventing burns due to high temperature), desirably, the surface temperature of the drying drum 76 is not higher than 75° C. (and more desirably, not higher than 60° C.).

By holding the recording medium 24 in such a manner that the recording surface thereof is facing outward on the outer circumferential surface of the drying drum 76 having this composition (in other words, in a state where the recording surface of the recording medium 24 is curved in a convex shape), and drying while conveying the recording medium in rotation, it is possible to prevent the occurrence of wrinkles or floating up of the recording medium 24, and therefore drying non-uniformities caused by these phenomena can be prevented reliably.

### Fixing Unit

The fixing unit 20 includes a fixing drum 84, a halogen heater 86, a fixing roller 88, and an inline sensor 90. The halogen heater 86, the fixing roller 88, and the inline sensor 90 are arranged in positions opposite the outer circumferential surface of the fixing drum 84 in this order from the upstream side in the rotation direction (counterclockwise direction in FIG. 1) of the fixing drum 84.

The fixing drum 84 a drum that holds the recording medium 24 on the outer circumferential surface thereof and rotationally conveys the recording medium 24. The rotation of the fixing drum 84 is driven and controlled by the below-described motor driver 176 (see FIG. 8). The fixing drum 84 has a hook-shaped holding device, and the leading end of the recording medium 24 can be held by this holding device. The recording medium 24 is rotationally conveyed by rotating the fixing drum 84 in a state in which the leading end of the recording medium 24 is held by the holding device. In this case, the recording medium 24 is conveyed in a state where the recording surface thereof faces outward, and the preheating by the halogen heater 86, the fixing treatment by the fixing roller 88 and the inspection by the inline sensor 90 are performed with respect to the recording surface. The fixing drum 84 may be provided with suction apertures on the outer circumferential surface thereof and connected to a suction device that performs suction from the suction apertures. As a result, the recording medium 24 can be held in a state of tight adherence to the outer circumferential surface of the fixing drum 84.

The halogen heater 86 is controlled to a prescribed temperature (for example, 180° C.), by which the preheating is performed with respect to the recording medium 24.

The fixing roller 88 is a roller member which applies heat and pressure to the dried ink to melt and fix the self-dispersible polymer particles in the ink so as to transform the ink into the film. More specifically, the fixing roller 88 is arranged so as to be pressed against the fixing drum 84, and a nip roller is configured between the fixing roller 88 and the fixing drum 84. As a result, the recording medium 24 is squeezed between the fixing roller 88 and the fixing drum 84, nipped under a prescribed nip pressure (for example, 0.15 MPa), and subjected to fixing treatment.

Further, the fixing roller 88 is configured by a heating roller in which a halogen lamp is incorporated in a metal pipe, for example made from aluminum, having good thermal conductivity and the rollers are controlled to a prescribed temperature (for example 60° C. to 80° C.). Where the recording medium 24 is heated with the heating roller, thermal energy not lower than a Tg temperature (glass transition temperature) of a latex included in the ink is applied and latex particles are melted. As a result, fixing is performed by penetration into the projections-recessions of the recording medium 24, the projections-recessions of the image surface are leveled out, and gloss is obtained.

The fixing unit 20 is provided with the single fixing roller 88 in the above-described embodiment; however, it is possible that a plurality of fixing rollers 88 depending on the thickness of image layer and Tg characteristic of latex particles. Furthermore, the surface of the fixing drum 84 may be controlled to a prescribed temperature (for example 60° C.).

On the other hand, the inline sensor 90 is a measuring device which measures the check pattern, moisture amount, surface temperature, gloss, and the like of the image fixed to the recording medium 24. A CCD sensor or the like can be used for the inline sensor 90.

With the fixing unit 20 of the above-described configuration, the latex particles located within a thin image layer formed in the drying unit 18 are melted by application of heat and pressure by the fixing roller 88. Thus, the latex particles can be reliably fixed to the recording medium 24. In addition, with the fixing unit 20, the fixing drum 84 is structurally separated from other drums. Therefore, the temperature of the fixing unit 20 can be freely set separately from the image formation unit 16 and the drying unit 18.

In particular, similarly to the drying drum 76 described above, the fixing drum 84 used in the present embodiment is constituted of a rotating conveyance body having a prescribed curvature and a surface temperature set to a prescribed temperature, and desirably, the curvature of the fixing drum 84 is in a range of not less than 0.002 (1/mm) and not more than 0.0033 (1/mm) or lower. If the curvature of the fixing drum 84 is less than 0.002 (1/mm), then even if the recording medium 24 is made to curve, an insufficient effect in correcting cockling of the medium is obtained, and if the curvature exceeds 0.0033 (1/mm), then the recording medium 24 is curved more than necessary and does not return to its original shape, but rather is output to the stack in a curved state.

It is desirable that the surface temperature of the fixing drum 84 is set to 50° C. or above. Drying is promoted by heating the recording medium 24 held on the outer circumferential surface of the fixing drum 84 from the rear surface, and therefore breaking of the image during fixing can be prevented, and furthermore, the strength of the image can be increased by the effects of the increased temperature of the image.

There are no particular restrictions on the upper limit of the surface temperature of the fixing drum 84, but desirably, it is set to 75° C. or lower (and more desirably, 60° C. or lower), from the viewpoint of maintenance characteristics.

Moreover, it is desirable that the fixing roller 88 used in the present embodiment has a surface hardness of not higher than 71°. By making the surface of the fixing roller 88, which is a heating and pressing member, softer, it is possible to expect a beneficial effect in the fixing roller following the indentations which occur in the recording medium 24 as a result of cockling, then it is possible to prevent the occurrence of fixing non-uniformities.

Furthermore, it is desirable to achieve a state where the moisture in the image has been evaporated off and the high-boiling-point organic solvent has been concentrated to a suitable concentration in the image (in other words, a state where the high-boiling-point organic solvent in the image remains at a rate of 4% or more of the ink droplet ejection volume), since the image deforms more readily with respect to the surface of the fixing roller (heating and pressing member) 88 during fixing, while having sufficient strength to avoid breaking of the image. Moreover, if a binder component is contained in the image, then it is desirable to preheat the image, so that the image can be expected to similarly follow the surface of the fixing roller 88, and fixing non-uniformities can be prevented yet more effectively.

Here, the “state where the high-boiling-point organic solvent in the image remains at a rate of 4% or more of the ink droplet ejection volume” means that the ratio of the remaining amount of high-boiling-point organic solvent in the image present on the surface of the recording medium with respect to the ink droplet ejection volume at the time of the fixing process is 4% or above.

By holding the recording medium 24 with the recording surface thereof facing outward on the outer circumferential surface of the fixing drum 84 having this composition (in other words, in a state where the recording surface of the recording medium 24 is curved in a convex shape), and heating and pressing to fix the image while conveying the recording medium in rotation, then even in a state where the moisture is not completely dried off and some degree of cockling is liable to occur, this cockling can be rectified.

Furthermore, since fixing can be carried out by the fixing roller 88 in a state where the surface of the recording medium 24 is pulled and stretched against the force that seeks to create indentations in the surface (recording surface) of the recording medium 24 due to the swelling of the pulp fibers, and hence the indentations caused by cockling have been alleviated and flattened, then it is possible to prevent the occurrence of fixing non-uniformities caused by cockling.

### Discharge Unit

As shown in FIG. 1, the discharge unit 22 is provided after the fixing unit 20. The discharge unit 22 includes a discharge tray 92, and a transfer body 94, a conveying belt 96, and a tension roller 98 are provided between the discharge tray 92 and the fixing drum 84 of the fixing unit 20 so as to face the discharge tray 92 and the fixing drum 84. The recording medium 24 is fed by the transfer body 94 onto the conveying belt 96 and discharged onto the discharge tray 92.

### Intermediate Conveyance Unit

The structure of the first intermediate conveyance unit 26 will be described below. The second intermediate conveyance unit 28 and the third intermediate conveyance unit 30 are configured identically to the first intermediate conveyance unit 26 and the explanation thereof will be omitted.

The first intermediate conveyance unit 26 is provided with an intermediate conveyance body 32, which is a drum for receiving the recording medium 24 from a drum of a previous stage, rotationally conveying the recording medium 24, and transferring it to a drum of the subsequent stage, and is mounted to be capable of rotating freely. The intermediate conveyance body 32 is rotated by a motor 188 (not shown in FIG. 1 and shown in FIG. 8), and the rotation thereof is driven and controlled by the below-described motor driver 176 (see FIG. 8). Further, the intermediate conveyance body 32 is provided on the outer circumferential surface thereof with a hook-shaped holding device, by which the leading end of the recording medium 24 can be held. In a state in which the leading end of the recording medium 24 is held by the holding device, the intermediate conveyance body 32 is rotated to rotationally convey the recording medium 24. In this case, the recording medium 24 is conveyed in a state where the recording surface thereof faces inward, whereas the non-recording surface thereof faces outward.

The recording medium 24 conveyed by the first intermediate conveyance unit 26 is transferred to a drum of the subsequent stage (that is, the image formation drum 70). In this case, the transfer of the recording medium 24 is performed by synchronizing the holding device of the intermediate conveyance unit 26 and the holding device (the gripper 102) of the image formation unit 16. The transferred recording medium 24 is held by the image formation drum 70 and rotationally conveyed.

### Structure of Ink Heads

Next, the structure of the inkjet heads is described. The inkjet heads 72M, 72K, 72C and 72Y for the respective colored inks have the same structure, and a reference numeral 150 is hereinafter designated to any of the inkjet heads (hereinafter also referred to simply as the heads).

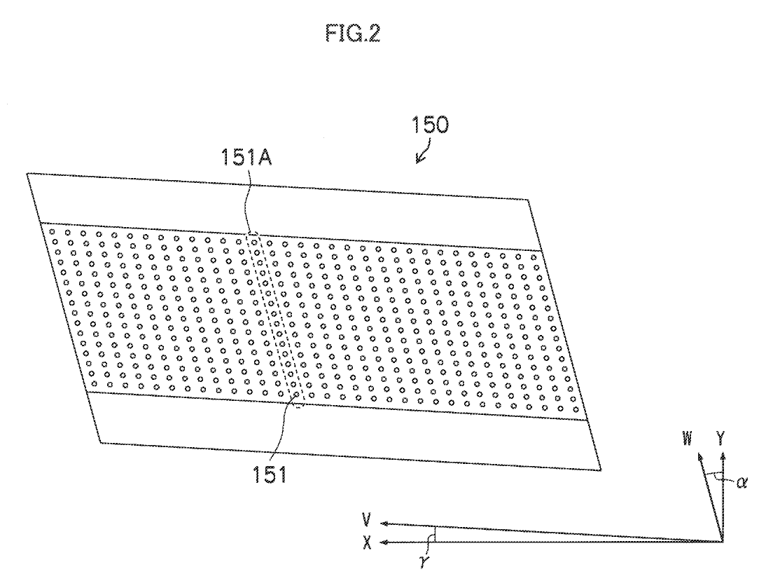

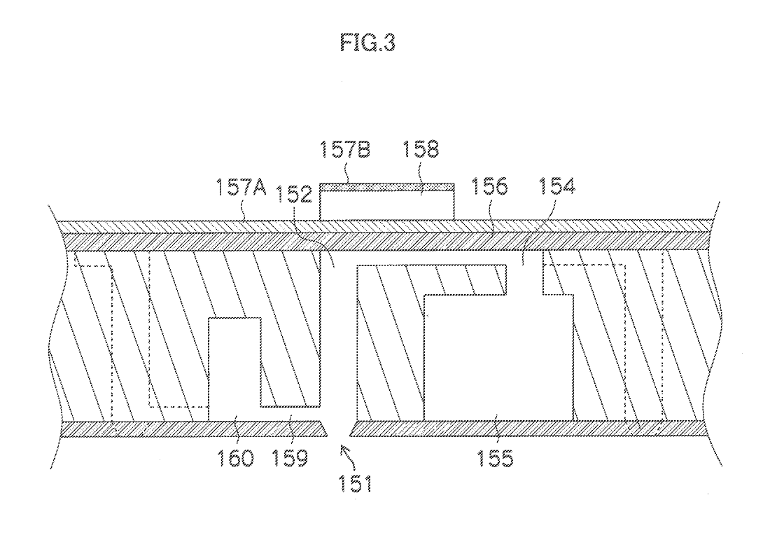

FIG. 2 is a plan diagram showing an example of the structure of a head 150 (a diagram viewed from the ink ejection surface side). Furthermore, FIG. 3 is a cross-sectional diagram showing the structure of the head 150.

In order to achieve a high density of the dot pitch formed onto the surface of the recording medium 24, it is necessary to achieve a high density of the nozzle pitch in the head 150. As shown in FIG. 2, the head 150 according to the present embodiment has a structure in which nozzles 151 forming ink ejection ports are arranged (two-dimensionally) in a matrix configuration.

In other words, the head has a structure comprising two or more nozzle columns 151A (one nozzle column is indicated by the dotted line surround in FIG. 2) in which a plurality of nozzles are arranged in a W direction (column direction) forming an angle of α with respect to the Y direction, which is the direction of conveyance of the recording medium 24 (see FIG. 1), and the nozzle columns 151A are arranged at a prescribed arrangement spacing in a V direction (column direction) forming an angle γ with the X direction that is perpendicular to the direction of conveyance of the recording medium 24. This nozzle arrangement achieves high density of the effective nozzle spacing (projected nozzle pitch) projected to an alignment in the X direction (or V direction) which is perpendicular to the direction of conveyance of the recording medium 24.

The matrix arrangement of the nozzles 151 shown in FIG. 2 is one example, and for example, it is also possible to employ a matrix arrangement in which a plurality of nozzle groups are arranged in the X direction, each nozzle group having a plurality of nozzles 151 arranged in an oblique column direction that forms an angle of θ(0°<θ<90°) with respect to the X direction.

The planar shape of the pressure chamber 152 provided for each nozzle 151 is substantially a square, and the nozzle 151 and an ink supply port 154 are disposed in both corners on a diagonal line of the square. The shape of the pressure chamber 152 is not limited to that of the present embodiment, and a variety of planar shapes, for example, a polygon such as a rectangle (rhomb, rectangle, etc.), a pentagon and a heptagon, a circle, and an ellipse can be employed.

As shown in FIG. 3, each pressure chamber 152 is connected to a supply flow channel 155 via the supply port 154. The supply flow channel 155 is connected to an ink tank (not shown in FIG. 3; indicated by reference numeral 162 in FIG. 4), which is an ink supply tank, and the ink supplied from the ink tank is supplied through the supply flow channel 155 to the respective pressure chambers 152.

A piezoelectric element 158 comprising a common electrode 157A and an individual electrode 157B is bonded to a diaphragm 156 which forms the surface of one portion (in FIG. 3, the ceiling) of the pressure chambers 152. When a drive voltage is applied between the individual electrode 157B and the common electrode 157A, the piezoelectric element 158 deforms, thereby changing the volume of the pressure chamber 152. This causes a pressure change which results in ink being ejected from the nozzle 151. When the piezoelectric element 158 returns to its original position after ejecting ink, the pressure chamber 152 is replenished with new ink from the common flow channel 155 via the supply port 154. If a metal material is used for the diaphragm 156, then this may serve as both the common electrode 157A and the diaphragm 156.

Furthermore, a circulation restrictor 159 is provided in the vicinity of the nozzle 151 and the opposite side of the circulation restrictor 159 from the nozzle 151 is connected to the circulation flow channel 160. By circulating the ink inside the nozzle 151 to the circulation flow channel 160 via the circulation restrictor 159, increase in the viscosity of the ink inside the nozzles 151 when ejection is not being performed can be prevented. The arrangement structure of the supply flow channel 155 and the circulation flow channel 160 shown in FIG. 3 are described hereinafter.

### Description of Maintenance Processing Unit

Next, the maintenance processing unit which carries out maintenance processing (restoration processing) of the inkjet heads 72M, 72K, 72C and 72Y shown in FIG. 1 will be described. In FIG. 4, the inkjet heads 72M, 72K, 72C and 72Y are depicted as a head 150.

FIG. 4 is a block diagram showing the approximate composition of a maintenance processing unit 161 which carries out maintenance processing in respect of the head 150, and the ink supply system of the head 150.

The ink supply tank 162 shown in FIG. 4 is a base tank for supplying ink to the head 150. The ink supply tank 162 may employ a mode where ink is replenished via a replenishment port (not illustrated) when the remaining amount of ink has become low, or a cartridge system where each tank is replaced individually. If the type of ink is changed in accordance with the usage, then a cartridge system is suitable. If a cartridge system is employed, desirably, the type of ink is identified by means of a bar code, or the like, on which ink type information is recorded, and ejection is controlled in accordance with the type of ink.

As shown in FIG. 4, a filter 163 for removing foreign material and air bubbles is provided between the ink supply tank 162 and the head 150. The filter mesh size is desirably equivalent to or less than the diameter of the nozzle and is commonly about 20 μm.

Although not shown in FIG. 4, a desirable composition is one in which a sub tank is provided in the vicinity of, or in an integrated fashion with, the head 150. The sub tank has a function of improving the damping effect to prevent internal pressure variations in the head 150, as well as improving refilling characteristics.

The maintenance processing unit 161 shown in FIG. 4 comprises a cap 164 which is placed tightly on the ink ejection surface (nozzle surface) 150A of the head 150, in other words, which caps the nozzle surface 150A, and a pump 165 which pressurizes or depressurizes the ink inside the nozzles via the cap 164; the maintenance processing unit 161 is disposed in the vicinity of the image formation unit 16 in FIG. 1.

As shown in FIG. 4, the pump 165 is connected to the ink supply tank 162 via the filter 166, and the ink recovered from the cap 164 is circulated to the ink supply tank via the filter 166. As shown in FIG. 5, the pump 165 also serves as a pump (not illustrated) for supplying ink from the ink supply tank 162 to the head 150.

More specifically, as shown in FIG. 5, it is possible to adopt a mode in which a switching valve 167 is provided between the filter 163 and the head 150, in such a manner that it is possible to switch between the flow channel from the filter 163 to the head 150 and the flow channel from the cap 164 to the filter 163, by means of the switching valve 167.

For example, when ink is supplied to the head 150 during normal operation, the flow channel from the filter 163 to the head 150 is selected and when ink is to be recovered from the cap 164 during a maintenance process, or the like, the flow channel from the cap 164 to the filter 163 is selected. The ink supply pump (not illustrated) is controlled in accordance with the switching of the flow channel.

Examples of maintenance processing performed by the maintenance processing unit 161 are preliminary ejection, suctioning, and the like, for removing ink of increased viscosity and air bubbles inside the head 150.

During printing or during standby, if the use frequency of a particular nozzle 151 has declined and the ink viscosity in the vicinity of the nozzle 151 has increased, then preliminary ejection is performed toward the cap 164, in order to expel the ink of increased viscosity (degraded ink).

Furthermore, in air bubbles have become mixed into the ink inside the head 150 (inside the pressure chambers 152 (see FIG. 3)), the cap 164 is placed tightly on the nozzle surface 150A of the head 150 and the ink mixed with air bubbles inside the pressure chambers 152 is removed by suctioning by the pump 165. The ink removed by suctioning is supplied to the ink supply tank 162 via the filter 166. This suctioning operation is also carried out to remove degraded ink of increased viscosity, whenever ink is filled into the head 150 initially, or when the head 150 starts to be used again after a prolonged idle period.

One example of ink used in the inkjet recording apparatus 10 described in the present embodiment (see FIG. 1) is an aqueous ink which contains pigment particles and a high-boiling-point organic solvent having an SP value of 30 or lower, at a ratio of 10 weight percent to 25 weight percent.

“High-boiling-point organic solvent” means an organic solvent having a boiling point of 240° C. or higher at one atmosphere, and more desirably, a boiling point 380° C. or higher at one atmosphere. An ink containing a high-boiling-point organic solvent is not liable to produce movement of dots after landing on the recording medium, produces good surface properties of the printed article, and displays little generation of organic solvent, and therefore is an ink which allows formation of high-quality images on normal paper. On the other hand, since the ink has properties which make it dry or solidify readily, then increased viscosity of the ink inside the head 150 (nozzles 151) is liable to occur, and during normal maintenance, it may not be possible to remove the ink of increased viscosity completely.

The maintenance processing unit 161 described in the present embodiment improves efficiency by adopting a composition in which an inkjet head provided with a plurality of nozzles is partially capped and pressurization and depressurization is carried out repeatedly in respect of the capped nozzles, and this unit corresponds to a case using an ink containing a high-boiling-point organic solvent which dries or solidifies readily.

FIGS. 6A to 6C are illustrative diagrams showing a schematic view maintenance processing relating to the present embodiment.

As shown in FIG. 6A, when the head 150 has been moved by a head movement mechanism (not illustrated) from a state where the head 150 is positioned in an image formation region directly above the image formation drum 70 (see FIG. 1) to a processing region of the maintenance processing unit 161 (see FIG. 4), the cap 164 is moved directly below the processing object nozzle of the head 150 by a cap movement mechanism (not illustrated).

Thereupon, cleaning liquid 168 is supplied to the surface of the cap 164 which makes contact with the nozzle surface 150A (the portion which seals the processing object nozzle). The amount of cleaning liquid supplied is sufficient for the cleaning liquid 168 to overflow from the cap 164 in such a manner that no air enters in between the cap 164 and the nozzle surface 150A when the cap 164 is placed in tight contact with the nozzle surface 150A (see FIG. 6B). A suitable liquid for use as the cleaning liquid is one having a function of separating adhering material from the nozzle surface 150A or a function of dissolving solidified ink, such as ink or pure water.

When the cleaning liquid is supplied to the cap 164, the cap 164 is moved upwards by the aforementioned cap movement mechanism, and the processing object region including the processing object nozzle is capped by the cap 164 (see FIG. 6C).

The portion of the cap 164 which makes contact with the nozzle surface 150A is made of a material such as soft rubber, or the like, so as not to damage the nozzle surface 150A upon contact with the nozzle surface 150A, and so as to avoid deformation due to contact between the nozzle surface 150A and the cap 164, and the like.

As shown in FIG. 6C, when the processing object region of the head 150 has been capped, the pump 165 is operated and pressurization processing and depressurization processing are carried out repeatedly at prescribed intervals. By carrying out this pressurization and depressurization, a portion of the solidified material inside the nozzles (ink of increased viscosity, ink which has formed a film, etc.) is dissolved by the cleaning liquid or by the ink inside the nozzles, and the solidified material which does not dissolve is expelled into the cap 164 from the nozzles, in addition to which air (air bubbles) incorporated inside the nozzles are also expelled into the cap 164.

The pressure during the pressurization and depressurization processing described above is desirably 5 kPa to 30 kPa approximately, and should be set appropriately in accordance with the degree of viscosity increase of the ink. Furthermore, the shorter the interval between pressurization and depressurization, the better. For example, if a tube pump is used, then it is possible to switch between pressurization and depressurization by switching the control signal (electrical signal), but if using a mechanism switching value, then time is required for the mechanical opening and closing operation. The overall processing time of the pressurization and depressurization process should be 5 sec to 30 sec.

Suctioning is carried out after the prescribed pressurization and depressurization processing has been completed. By expelling the ink from the nozzle surface 150 toward the cap 164 immediately after the maintenance processing, the solidified material and air bubbles expelled into the cap 164 are prevented from entering inside the nozzles. In the present embodiment, “suctioning” means applying a pressure in the direction from the interior of the nozzles 151 toward the exterior, and “pressurization” means applying a pressure in the direction from the exterior of the nozzles 151 toward the interior.

Desirably, the pump 165 is one which enables easy switching of pressurization and depressurization, such as a tube pump or diaphragm pump. On the other hand, if the pump of the ink supply system (not illustrated) is used and a composition is adopted where the flow channel between the pump and the cap 164 is opening and closed mechanically by a switching valve 167 (see FIG. 5), then it is possible to adapt to cases where a larger pressure is needed, or cases where the load on the head 150 is impaired by pulsation.

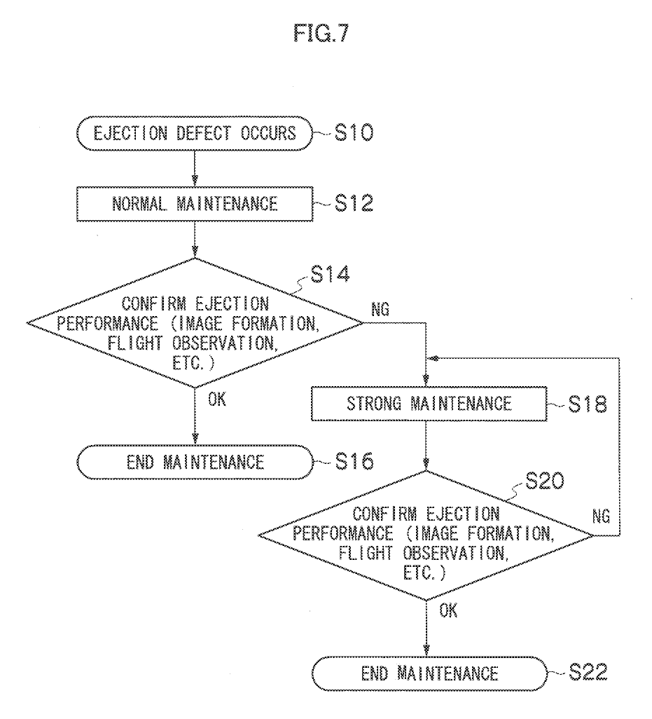

FIG. 7 is a flowchart showing the sequence of maintenance processing in the maintenance processing unit 161. The maintenance processing described in the present example includes normal maintenance processing and strong maintenance processing which is employed when the normal maintenance processing is not sufficient.

Strong maintenance processing means a mode which includes processing where a portion of the nozzle surface 150A is capped by the cap 164, and pressurization and depressurization processing is carried out in respect of the capped processing object region.

As shown in FIG. 7, it is determined whether or not there is an ejection abnormality first, and when it is determined that an ejection abnormality has occurred (step S10), the operation mode of the apparatus is changed from an image formation mode to a maintenance mode. When the mode transfers to the maintenance mode, the head 150 is moved to the maintenance processing region.

In the maintenance mode, firstly, normal maintenance processing (a first restoration processing step) is carried out (step S12), whereupon the ejection performance is confirmed (step S14). In the “normal maintenance processing” in step S12, prescribed processing is carried out in respect of all of the nozzles. “Prescribed processing” means at least one of suctioning (capping the nozzle surface 150A with the cap 164 and operating the pump 165 (see FIG. 4) or the pump of the ink supply system and expelling the ink inside the head 150 from the nozzles 151), pressurization (capping the nozzle surface with the cap 164, operating the pump 165 (or the pump of the ink supply system) and returning the ink from the cap 164 into the head 150), or wiping (processing for wiping the nozzle surface 150A using a wiping member such as a blade or cloth).

The confirmation of ejection performance in step S14 is carried out by a method (image reading) of printing a test pattern, reading the test pattern by an imaging element (sensor), such as a CCD, and confirming the presence or absence of ejection abnormalities on the basis of the test pattern reading results, or a method (flight observation) which observes the flight of ink directly by means of a sensor, or the like.

In step S14, if it is determined that there is no abnormality in the ejection performance of any of the nozzles (OK verdict), the maintenance mode is terminated (step S16) and the apparatus returns to image formation mode.

On the other hand, in step S14, if a nozzle having an abnormality in the ejection performance is discovered (NG verdict), the nozzle suffering the ejection abnormality is identified, and strong maintenance processing (a second restoration processing step) is carried out in respect of the ejection abnormality nozzle (step S18). When the strong maintenance mode is terminated, the ejection performance of the nozzle for which strong maintenance processing has been carried out is confirmed (step S20).

At step S20, if it is determined that there is no abnormality in the ejection performance of the nozzle where strong maintenance processing has been carried out (OK verdict), the maintenance mode is ended (step S22) and the apparatus returns to the image formation mode.

At step S20, if it is determined that there is an abnormality in the ejection performance of the nozzle for which strong maintenance processing has been carried out (NG verdict), the procedure returns to step S18 and the strong maintenance processing is carried out again in respect of the nozzle in question. More specifically, when a nozzle is determined to have an abnormality in the ejection performance in step S20, strong maintenance processing is carried out repeatedly until it is determined that there is no abnormality in the ejection characteristics.

In this way, by adopting a composition where strong maintenance processing is carried out partially in respect of nozzles which are not restored sufficiently in normal maintenance processing, then nozzles which have a significant extent of solidification and filming are restored reliably, and maintenance processing can be carried out efficiently in the whole head.

### Description of Control System

FIG. 8 is a block diagram of the main portion of a system configuration of the inkjet recording apparatus 10. The inkjet recording apparatus 10 includes a communication interface 170, a system controller 172, a memory 174, the motor driver 176, a heater driver 178, a maintenance control unit 179, a printing control unit 180, an image buffer memory 182, a head driver 184, a sensor 185, a program storage unit 190, a treatment liquid application control unit 196, a drying control unit 197, and a fixing control unit 198.

The communication interface 170 is an interface unit that receives image data sent from a host computer 186. A serial interface such as USB (Universal Serial Bus), IEEE 1394, Ethernet, and a wireless network, or a parallel interface such as Centronix can be applied as the communication interface 170. A buffer memory (not shown) may be installed in the part of the interface to increase the communication speed. The image data sent from the host computer 186 are introduced into the inkjet recording apparatus 10 through the communication interface 170 and temporarily stored in the memory 174.

The memory 174 is a storage device that temporarily stores the images inputted through the communication interface 170 and reads/writes the data via the system controller 172. The memory 174 is not limited to a memory composed of semiconductor elements and may use a magnetic medium such as a hard disk.

The system controller 172 includes a central processing unit (CPU) and a peripheral circuitry thereof, functions as a control device that controls the entire inkjet recording apparatus 10 according to a predetermined program, and also functions as an operational unit that performs various computations. Thus, the system controller 172 controls various units such as the communication interface 170, the memory 174, the motor driver 176, the heater driver 178, the maintenance control unit 179, the treatment liquid application control unit 196, the drying control unit 197 and the fixing control unit 198, performs communication control with the host computer 180, performs read/write control of the memory 174, and also generates control signals for controlling the various units.

Programs that are executed by the CPU of the system controller 172 and various data necessary for performing the control are stored in the memory 174. The memory 174 may be a read-only storage device or may be a writable storage device such as EEPROM. The memory 174 can be also used as a region for temporary storing image data, a program expansion region, and a computational operation region of the CPU.

Various control programs are stored in the program storage unit 190, and a control program is read out and executed in accordance with commands from the system controller 172. The program storage unit 190 may use a semiconductor memory, such as a ROM, EEPROM, or a magnetic disk, or the like. The program storage unit 190 may be provided with an external interface, and a memory card or PC card may also be used. Naturally, a plurality of these storage media may also be provided. The program storage unit 190 may also be combined with a storage device for storing operational parameters, and the like (not shown).

The motor driver 176 drives a motor 188 in accordance with commands from the system controller 172. In FIG. 8, the plurality of motors disposed in the respective sections of the inkjet recording apparatus 10 are represented by the reference numeral 188. For example, the motor 188 shown in FIG. 8 includes the motors that drive the paper transfer drum 52, the treatment liquid drum 54, the image formation drum 70, the drying drum 76, the fixing drum 84 and the transfer body 94 shown in FIG. 1, and the motors that drive the intermediate conveyance bodies 32 in the first, second and third intermediate conveyance units 26, 28 and 30.

The heater driver 178 is a driver that drives the heater 189 in accordance with commands from the system controller 172. In FIG. 8, the plurality of heaters disposed in the inkjet recording apparatus 10 are represented by the reference numeral 189. For example, the heater 189 shown in FIG. 8 includes the halogen heaters 80 in the solvent dryer 78 arranged in the drying unit 18 shown in FIG. 1, and the heaters that heat the surfaces of the drying drum 76 and the fixing drum 84 shown in FIG. 1.

The treatment liquid application control unit 196, the drying control unit 197 and the fixing control unit 198 control the operations of the treatment liquid application device 56, the solvent dryer 78 and the fixing roller 88, respectively, in accordance with commands from the system controller 172.

The printing control unit 180 has a signal processing function for performing a variety of processing and correction operations for generating signals for print control from the image data within the memory 174 according to control of the system controller 172, and supplies the generated printing data (dot data) to the head driver 184. The required signal processing is implemented in the printing control unit 180, and the ejection amount and ejection timing of droplets in the heads 150 are controlled through the head driver 184 based on the image data. As a result, the desired dot size and dot arrangement are realized.

The printing control unit 180 is provided with the image buffer memory 182, and data such as image data or parameters are temporarily stored in the image buffer memory 182 during image data processing in the printing control unit 180. A mode is also possible in which the printing control unit 180 and the system controller 172 are integrated and configured by one processor.

The head driver 184 generates drive signals for driving the piezoelectric elements 158 of the heads 150, on the basis of the dot data supplied from the print controller 180, and drives the piezoelectric elements 158 by applying the generated drive signals to the piezoelectric elements 158. A feedback control system for maintaining constant drive conditions in the recording heads 150 may be included in the head driver 184 shown in FIG. 8.

The sensor 185 represents the sensors disposed in the respective sections of the inkjet recording apparatus 10. For example, the sensor 185 includes the inline sensor 90 shown in FIG. 1, temperature sensors, position determination sensors, pressure sensors, an image capturing element (capturing sensor) for reading a test image, and a sensor for observing the flight status of ink. The output signals of the sensor 185 are sent to the system controller 172, and the system controller 172 controls the respective sections of the inkjet recording apparatus 10 by sending the command signals to the respective sections in accordance with the output signals of the sensor 185.

The maintenance control unit 179 is a processing block which controls the maintenance processing unit 161 that carries out maintenance of the inkjet head 150 (see FIG. 4) on the basis of control signals sent from the system controller 172.

In other words, if it is determined that there is an ejection abnormality nozzle on the basis of the reading results by the sensor 185, then the system controller 172 sends operating commands to the motors included in the movement mechanism of the head 150 and the movement mechanism of the cap 164 (see FIG. 4), via the motor driver 176, as well as sending operating commands to the maintenance processing unit 161 via the maintenance control unit 179.

Maintenance processing is carried out by the maintenance processing unit 161 and the respective units relating to the maintenance process operating on the basis of the operating commands sent by the system controller 172.

### Variation of Capping Region

Next, the capping regions which are capped simultaneously by the cap 164 (see FIG. 4) will be described.

### Variation 1

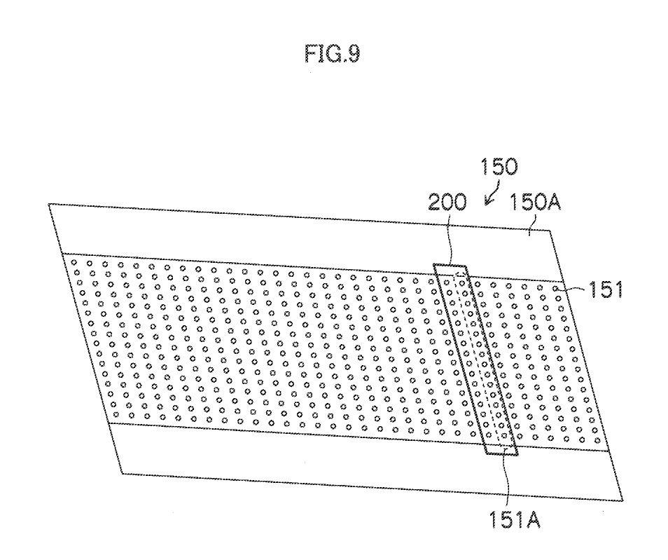

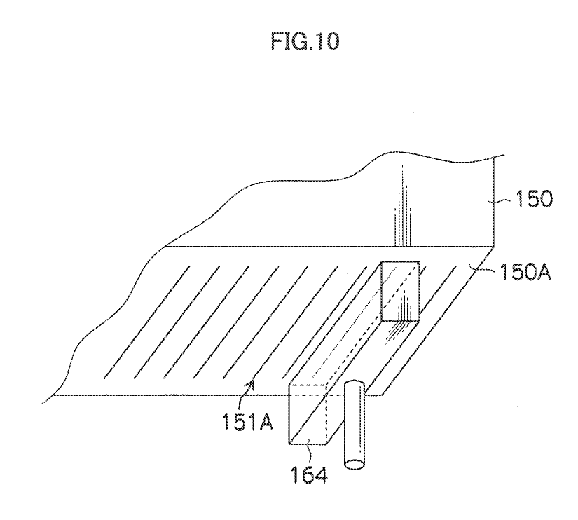

FIG. 9 is a diagram showing one example of a region (capping region) 200 which is capped simultaneously by the cap 164 (see FIG. 10) (the diagram shows a plan view of the head 150 viewed from the nozzle surface 150A side).

The capping region 200 shown in FIG. 9 includes nozzles 151 belonging to two nozzle rows 151A. FIG. 10 is a perspective diagram showing a state where the capping region 200 in FIG. 9 is capped by the cap 164. The cap 164 shown in FIG. 10 has a length corresponding to the length of the nozzle columns 151A, in the breadthways direction of the head 150 (the W direction in which the nozzle columns 151A are formed; see FIG. 2).

By adopting a composition in which one or a plurality of nozzle columns 151A can be capped simultaneously, it is possible to cap successively all of the nozzles provided in the head 150, by moving the cap 164 in the lengthwise direction of the head 150 only, without moving the cap 164 in the breadthways direction of the head 150.

### Variation 2

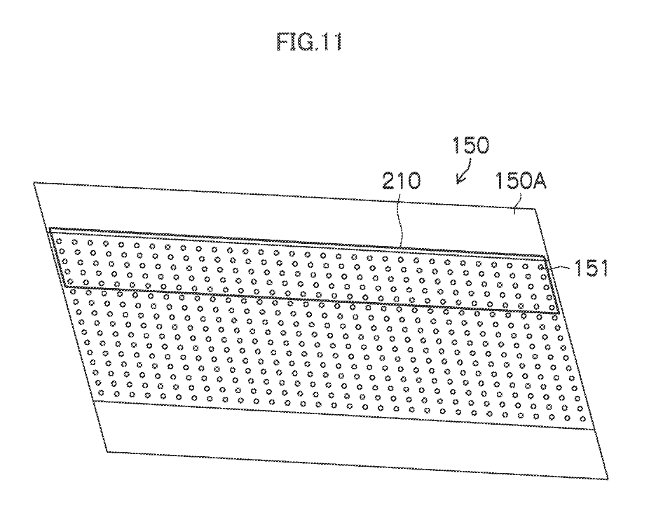

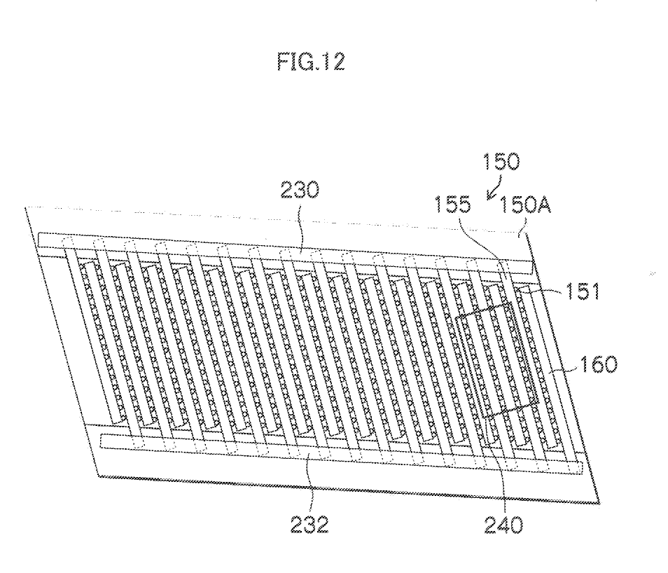

FIG. 11 is an illustrative diagram showing a further mode of the capping region (a plan diagram of the head 150 viewed from the nozzle surface 150A side). The capping region 210 shown in FIG. 11 has a length corresponding to the plurality of nozzles 151 (nozzle columns 151A) arranged in the lengthwise direction of the head 150 (V direction, see FIG. 2).

### Variation 3

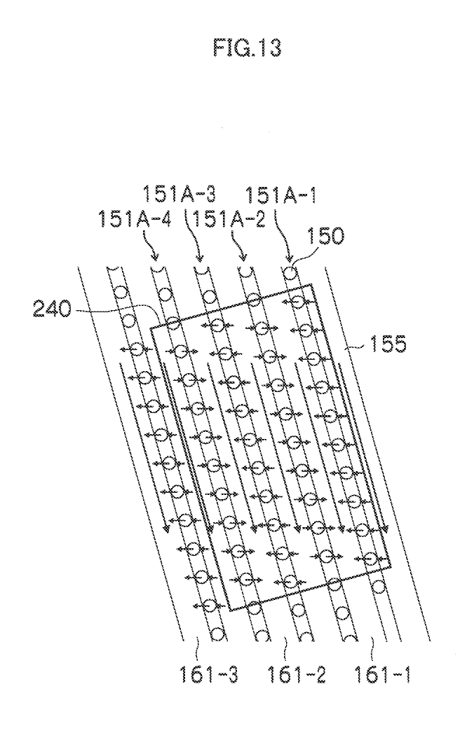

FIG. 12 is an illustrative diagram showing yet a further mode of the capping region and FIG. 13 is a partial enlarged diagram of FIG. 12. The head 150 shown in FIG. 12 is composed in such a manner that supply flow channels 155 and circulation flow channels 160 following the W direction (see FIG. 2) which is substantially parallel to the nozzle columns 151A are arranged alternately in the V direction, and furthermore the supply flow channels 155 are arranged between two nozzle columns 151A so that ink is supplied from one supply flow channel 155 to the two nozzle columns 151A. Furthermore, a circulation flow channel 160 is arranged between pairs of nozzle columns in such a manner that ink is circulated from two nozzle columns 151A to one circulation flow channel 160.

Moreover, the head has a flow channel structure where all of the supply flow channels 155 are connected to a supply main flow 230 formed in the lengthwise direction of the head 150, and all of the circulation flow channels 160 are connected to a circulation main flow 232 formed in the lengthwise direction of the head.

In a head 150 having a flow channel structure of this kind, the capping region 240 shown in FIG. 12 simultaneously caps at least a portion of two nozzle columns 151A to which ink is supplied from a common supply flow channel 155, or simultaneously caps at least a portion of two nozzle columns 151A from which ink is circulated to a common circulation flow channel 160.

As shown in FIG. 13, the capping region 240 simultaneously caps a portion of the nozzle column 151A-1 and a portion of the nozzle column 151A-2 from which ink is circulated to the circulation flow channel 160-1, as well as simultaneously capping a portion of the nozzle column 151A-3 and a portion of the nozzle column 151A-4 which circulates ink to the circulation flow channel 160-2.

According to this mode, nozzles which have a common supply flow channel 155 or circulation flow channel are capped simultaneously and are subjected to maintenance processing simultaneously, whereby foreign material inside the nozzles can be removed more efficiently.

Consequently, the shape (structure) of the portion of the cap 164 which caps the nozzle surface 150A should be a shape corresponding to the arrangement of nozzles 151.

According to the inkjet recording apparatus 10 having the composition described above, in maintenance processing of a head 150 in which a plurality of nozzles 151 are arranged in a matrix configuration, it is possible to concentrate the pressure which previously escaped from normally functioning nozzles, at those nozzles that are the object of processing, by capping, using the cap 164, a portion of the nozzle surface 150A including nozzles which are determined to have an ejection abnormality, and therefore the pressure can be used efficiently. Furthermore, by subjecting the capped nozzles 151 to pressurization and depressurization processing which alternately repeats pressurization and depressurization, highly efficient maintenance processing is carried out by means of a smaller number of operations than in the related art (in a shorter time than in the related art).

### APPLICATION EXAMPLE Next, application examples of the present invention will be described.

### First Application Example

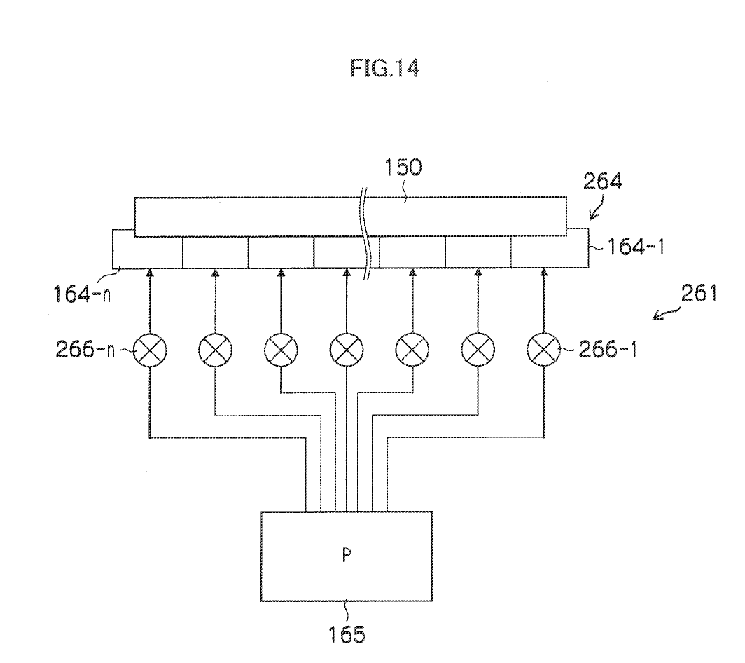

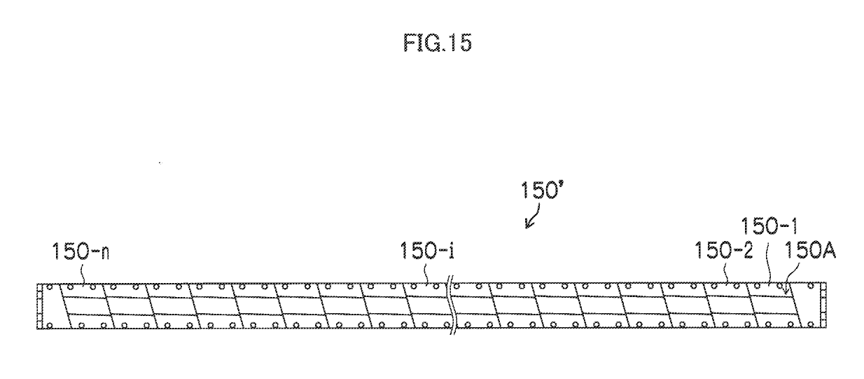

FIG. 14 is a block diagram showing the approximate composition of a maintenance processing unit relating to an application example of the present invention.

In order to carry out maintenance processing of the whole of the head 150 by using the maintenance processing unit 161 described above, it is necessary to carry out processing several times while moving the cap 164, and hence there is a possibility that a long time is needed for the whole process.

FIG. 14 is a block diagram showing a composition for resolving the problem described above. The maintenance processing unit 261 shown in FIG. 14 has a structure in which a single cap structure body 264 is formed by aligning together n caps 164 (164-1 to 164-n) in the lengthwise direction of the head 150, in such a manner that the whole of the head 150 can be capped simultaneously.

Furthermore, switching valves 266-1 to 266-n are provided for the caps 164-1 to 164-n, thereby achieving a composition where it is possible to select the flow channel which is connected to the pump 165 inside the caps 164-1 to 164-n, by opening any one of the switching valves 266-1 to 266-n and closing the other switching valves.

Moreover, the region which can be capped by the caps 164-1 to 164-n is composed so as to include at least one group of nozzles (nozzle column 151A) which share a common supply flow channel 155 or a common circulation flow channel 160 (see FIG. 12 and FIG. 13).

According to this first application example, reduced overall processing time can be expected compared to a case where maintenance processing is carried out in respect of the whole head 150 by moving the cap 164.

### Second Application Example

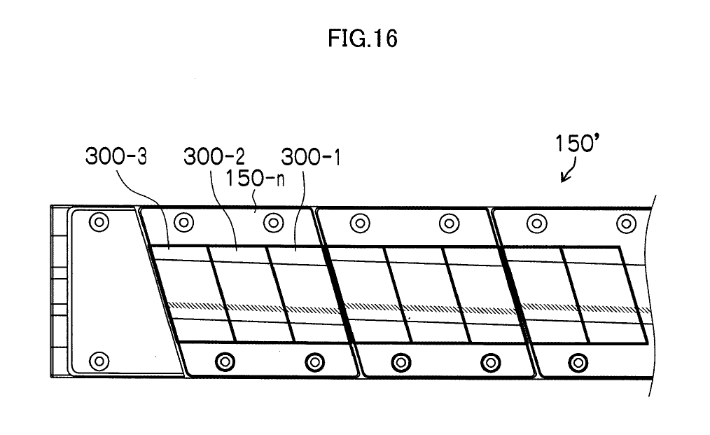

FIG. 15 is a plan diagram showing a full line type head 150′ composed by joining together a plurality of head modules 150-1 to 150-n (150-i, where i is an integer between 1 and n), as viewed from the nozzle surface 150A side, and FIG. 16 is a partial enlarged diagram of FIG. 15.

In this example, capping is performed respectively for each head module 150-i in a head 150′ composed by a plurality of head modules 150-i joined together, and furthermore, the nozzle arrangement region in each head module 150-i is divided equally (into three sections), which respectively form capping regions 300-1 to 300-3.

More specifically, the cap described in the present example has a structure comprising three caps joined together, each cap corresponding to a capping region 300-1 (300-2, 300-3), and is composed in such a manner that any one of the three caps can be connected selectively to a pump.

Maintenance processing is carried out successively in respect of the capping regions 300-1 to 300-3 in one head module 150-i, and furthermore, when the maintenance processing for one head module 150-i has been completed, maintenance processing is carried out for the next head module 150-i.

In this way, maintenance processing is successively carried out for each of the plurality of head modules 150-i, respectively, in the whole of the head 150′ which is formed a plurality of head modules 150-i that are joined together.

According to this second application example, by adopting a shape and structure for the cap which corresponds to that of the head module 150-i, it is possible to simplify the positioning of the cap with respect to the head 150′. Furthermore, since each head module 150-i is capped simultaneously by a cap structure in which a plurality of caps are joined together, and since maintenance processing is carried out respectively in each cap while switching the flow channel, then shortening of the processing time can be anticipated for each head module 150-i.

In the present embodiments, the inkjet recording apparatus has been described which records a color image by ejecting and depositing color inks onto a recording medium as one example of an image forming apparatus; however, the present invention can also be applied to an image forming apparatus which forms a prescribed pattern shape on a substrate by means of a resin liquid, or the like, in order, for instance, to form a mask pattern or to print wiring of a printed wiring board.

Liquid ejection apparatuses and head maintenance methods according to embodiments of the present invention have been described in detail above, but the present invention is not limited to the aforementioned examples, and it is of course possible for improvements or modifications of various kinds to be implemented, within a range which does not deviate from the essence of the present invention.

### Appendix

As has become evident from the detailed description of the embodiments given above, the present specification includes disclosure of various technical ideas below.

One aspect of the invention relates to a liquid ejection apparatus comprising: an inkjet head including: a plurality of nozzles which eject liquid containing a water-soluble high-boiling-point organic solvent having an SP value of 30 or lower at a concentration of 10 weight percent or higher and 25 weight percent or lower, a plurality of liquid chambers connected to the plurality of nozzles respectively, and a plurality of supply flow channels to any of which each of the plurality of nozzles is connected and which supply the liquid to the plurality of nozzles via the plurality of liquid chambers; a capping device configured to simultaneously cap the nozzles connected to the same supply flow channel, from a liquid ejection surface side of the inkjet head; a pressure application device which applies pressure to the liquid inside the nozzles via the capping device; and a pressure control device which controls the pressure application device so as to repeat pressurization and depressurization with respect to the liquid inside the nozzles.

According to this aspect of the invention, since the nozzles which are capped simultaneously by the capping device are limited to nozzles which receive supply of liquid from the same supply flow channel, then it is possible to prevent dispersion of the pressure applied when in the capped state and therefore maintenance efficiency can be improved.

A liquid which contains a water-soluble high-boiling-point organic solvent having an SP value of 30 or lower, at a concentration of 10 weight percent or higher and 25 weight percent or lower, has properties whereby the liquid is liable to solidify by drying, and therefore particularly beneficial effects are displayed in the maintenance of an inkjet head which a liquid of this kind.

A desirable mode is one where a cleaning liquid supply device is provided to supply cleaning liquid to the portion of the capping device which seals the liquid ejection surface, in a state where the ejection surface is sealed by the capping device, and capping is performed in a state where the portion of the capping device which seals the liquid ejection surface is filled with cleaning liquid.

According to this mode, air bubbles are prevented from infiltrating inside the nozzles during capping and the cleaning liquid makes contact with the solidified material and the like inside the nozzles, and therefore dissolution and dispersion of the solidified material, and the like, into the cleaning liquid are promoted.

An inkjet head is a liquid ejection head which ejects liquid from nozzles (openings) provided in a liquid ejection surface, using an inkjet method, and one example of the composition of such a head is a mode comprising liquid chambers connected to the nozzles and pressurization devices which apply pressure to the liquid inside the liquid chambers.

Possible examples of the liquid is ink (color ink) which forms images on a recording medium, or liquid (resist, or the like) containing resin particles which form a pattern on a substrate, or the like.

One example of a liquid ejection apparatus is an inkjet recording apparatus which ejects ink from nozzles by means of an inkjet method.

Desirably, the inkjet head includes a plurality of circulation flow channels connected to the plurality of nozzles in such a manner that each of the plurality of nozzles is connected to any one of the plurality of circulation flow channels, and the capping device is configured to simultaneously cap the nozzles connected to the same circulation flow channel.

According to this mode, in a composition which comprises circulation flow channels connected to the respective nozzles, it is possible to improve the efficiency of the maintenance processing by carrying out maintenance processing by simultaneously capping the plurality of nozzles which are connected to the same circulation flow channel.

Desirably, the inkjet head is configured in such a manner that the plurality of nozzles are arranged two-dimensionally in a row direction and a column direction forming an angle of θ(0°<θ<90°) with respect to the row direction, and the plurality of supply flow channels are arranged in the row direction in such a manner that the plurality of supply flow channels are respectively provided along nozzle columns formed by the nozzles aligned in the column direction and supply the liquid to the nozzles of the nozzle columns, and the capping device is configured to simultaneously cap the nozzles which belong to the same nozzle column and to which the liquid is supplied from the same supply flow channel.

According to this mode, it is possible to improve the efficiency of maintenance processing in an inkjet head in which a plurality of nozzles are arranged in a matrix configuration.

Desirably, the inkjet head is configured in such a manner that the plurality of supply flow channels are provided at every other interval between two nozzle columns that are adjacent to each other in the row direction, and each of the plurality of supply flow channels supplies the liquid to the nozzles adjacent on both sides of thereof in the row direction.

According to this mode, in a composition which supplies liquid to two nozzle columns from one supply flow channel, it is possible to carry out maintenance processing in a concentrated fashion with respect to nozzles which are connected to one supply flow channel.

In the case of this mode, it is desirable that all of the nozzles connected to the same supply flow channel should be capped simultaneously.

Desirably, the inkjet head is configured in such a manner that the plurality of nozzles are arranged two-dimensionally in a row direction and a column direction forming an angle of θ(0°<θ<90°) with respect to the row direction, and a plurality of circulation flow channels are arranged in the row direction in such a manner that the plurality of circulation flow channels are respectively provided along nozzle columns formed by the nozzles aligned in the column direction and are connected to the nozzles of the nozzle columns, and the capping device is configured to simultaneously cap the nozzles which belong to the same nozzle column and are connected to the same circulation flow channel.

According to this mode, it is possible to carry out maintenance processing in a concentrated fashion with respect to nozzles which are connected to a particular circulation flow channel.

In the case of this mode, it is desirable that all of the nozzles connected to the same circulation flow channel should be capped simultaneously.

Desirably, the inkjet head is configured in such a manner that the supply flow channels and the circulation flow channels are alternately arranged between the nozzle columns that are adjacent to each other in the row direction.

According to this mode, it is possible to carry out maintenance processing in a concentrated fashion with respect to nozzles which are connected to the same supply flow channel or the same circulation flow channel.

Desirably, the capping device includes a plurality of modules which each are shorter than a length of the inkjet head in a lengthwise direction and which are joined together so as to have a length corresponding to the length of the inkjet head in the lengthwise direction, wherein the liquid ejection apparatus further comprises: a connection switching device which selectively switches connection between each of the plurality of modules and the pressure application device; and a switching control device which controls the connection switching device so as to successively switch the connection switching device to perform processing of repeating the pressurization and the depressurization of the whole inkjet head.

This mode is effective in an inkjet recording apparatus which comprises a conveyance device for conveying the inkjet head and a medium onto which liquid is ejected from the inkjet head, relatively in the medium conveyance direction that is substantially perpendicular to the row direction, and which has a full line head having a structure wherein the length in the row direction of the nozzle arrangement region of the inkjet head where the nozzles are arranged exceeds the length of the medium in the row direction.

By capping in a state where cleaning liquid has been filled into the portion of the capping device which seals the liquid ejection surface, it is possible to make the cleaning liquid contact the solidified material, and the like, that has occurred inside the nozzles before carrying out the pressurization and depressurization processing, and this solidified material can be caused to dissolve or disperse into the cleaning liquid.

Desirably, the liquid ejection apparatus further comprises an ejection abnormality determination device which determines presence or absence of an ejection abnormality in the plurality of nozzles, wherein the capping device simultaneously caps the nozzles including a nozzle determined to have the ejection abnormality by the ejection abnormality determination device.

According to this mode, maintenance processing is carried out efficiently and reliably in respect of nozzles suffering an ejection abnormality.

Desirably, the liquid ejection apparatus further comprises an expulsion device which expels the liquid from the nozzles after processing for repeating pressurization and depressurization is performed by the pressure application device.

According to this mode, even if foreign matter has been sucked inside the nozzles after the pressurization and depressurization process, it is possible to expel this foreign matter.

Desirably, the plurality of nozzles are arranged two-dimensionally in a row direction and a column direction forming an angle of θ(0°<θ<90°) with respect to the row direction in such a manner that nozzle columns each formed by the nozzles aligned in the column direction are arranged in the row direction, and the capping device has a length in the column direction corresponding to the nozzle columns so as to simultaneously cap the nozzles forming one or more nozzle columns

Desirably, the plurality of nozzles are arranged two-dimensionally in a row direction and a column direction forming an angle of θ(0°<θ<90°) with respect to the row direction in such a manner that nozzle columns each formed by the nozzles aligned in the column direction are arranged in the row direction, and the capping device has a length in the row direction corresponding to the nozzles aligned in the row direction so as to simultaneously cap the nozzles aligned in the row direction.

Desirably, the inkjet heads includes a plurality of head modules joined together, and the capping device simultaneously caps the nozzles with respect to each of the plurality of head modules.

Desirably, each of the plurality of head modules has a plurality of nozzle regions to which the nozzles included in each of the plurality of head modules are assigned, the capping device includes a plurality of capping modules corresponding to the plurality of nozzle regions respectively, and the liquid ejection apparatus further comprises a connection switching device which selectively switches connection between each of the plurality of capping modules and the pressure application device, and a switching control device which controls the connection switching device.

Desirably, the liquid ejection apparatus further comprises an ink tank connected to the inkjet head and the capping device in such a manner that the liquid is supplied to the inkjet head from the ink tank and is returned to the ink tank via the capping device.

Desirably, the inkjet head and the capping device are connected to the ink tank via a switching valve that switches between connection from the ink tank to the inkjet head and connection from the capping device to the ink tank.

Another aspect of the present invention relates to a head maintenance method for an inkjet head includes a plurality of nozzles which eject liquid containing a water-soluble high-boiling-point organic solvent having an SP value of 30 or lower at a concentration of 10 weight percent or higher and 25 weight percent or lower, a plurality of liquid chambers connected to the plurality of nozzles respectively, and a plurality of supply flow channels which supply the liquid to the plurality of nozzles via the plurality of liquid chambers and to any of which each of the plurality of nozzles is connected, the head maintenance method comprising: a capping step of simultaneously capping the nozzles connected to the same supply flow channel from a liquid ejection surface side of the inkjet head; and a pressurization and depressurization step of repeating pressurization and depressurization of the liquid inside the nozzles via a capping device.

A desirable mode is one where the capping includes a cleaning liquid depositing step of depositing cleaning liquid onto the portion of the capping device which seals the liquid ejection surface, and the nozzles are sealed by the capping device after cleaning liquid has been deposited onto the portion of the capping device which seals the liquid ejection surface.

Desirably, the head maintenance method further comprises an expulsion step of expelling the liquid from the nozzles after the pressurization and depressurization step.

According to this mode, even if foreign matter has been sucked inside the nozzles after the pressurization and depressurization step, it is possible to expel this foreign matter.

Desirably, the head maintenance method further comprises: an ejection abnormality determination step of determining whether or not an ejection abnormality has occurred in any of the plurality of nozzles; a first restoration processing step of, when it is determined in the ejection abnormality determination step that the ejection abnormality has occurred in any of the plurality of nozzles, carrying out restoration processing on the nozzle where the ejection abnormality has occurred; and a second restoration processing step of, when further restoration processing is required for the nozzle after the first restoration processing step, carrying out the capping step and the pressurization and depressurization step.

According to this mode, maintenance processing is carried out efficiently and reliably in respect of nozzles suffering an ejection abnormality.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection apparatus comprising:
an inkjet head including:
a plurality of nozzles which eject liquid containing a water-soluble high-boiling-point organic solvent having an SP value of 30 or lower at a concentration of 10 weight percent or higher and 25 weight percent or lower,
a plurality of liquid chambers connected to the plurality of nozzles respectively, and
a plurality of supply flow channels to any of which each of the plurality of nozzles is connected and which supply the liquid to the plurality of nozzles via the plurality of liquid chambers;
a capping device configured to simultaneously cap the nozzles connected to the same supply flow channel, from a liquid ejection surface side of the inkjet head;
a pressure application device which applies pressure to the liquid inside the nozzles via the capping device; and
a pressure control device which controls the pressure application device so as to repeat pressurization and depressurization with respect to the liquid inside the nozzles.

2. The liquid ejection apparatus as defined in claim 1, wherein:
the inkjet head includes a plurality of circulation flow channels connected to the plurality of nozzles in such a manner that each of the plurality of nozzles is connected to any one of the plurality of circulation flow channels, and
the capping device is configured to simultaneously cap the nozzles connected to the same circulation flow channel.

3. The liquid ejection apparatus as defined in claim 1, wherein:
the inkjet head is configured in such a manner that the plurality of nozzles are arranged two-dimensionally in a row direction and a column direction forming an angle of θ(0°<θ<90°) with respect to the row direction, and the plurality of supply flow channels are arranged in the row direction in such a manner that the plurality of supply flow channels are respectively provided along nozzle columns formed by the nozzles aligned in the column direction and supply the liquid to the nozzles of the nozzle columns, and
the capping device is configured to simultaneously cap the nozzles which belong to the same nozzle column and to which the liquid is supplied from the same supply flow channel.

4. The liquid ejection apparatus as defined in claim 3, wherein the inkjet head is configured in such a manner that the plurality of supply flow channels are provided at every other interval between two nozzle columns that are adjacent to each other in the row direction, and each of the plurality of supply flow channels supplies the liquid to the nozzles adjacent on both sides of thereof in the row direction.

5. The liquid ejection apparatus as defined in claim 1, wherein:
the inkjet head is configured in such a manner that the plurality of nozzles are arranged two-dimensionally in a row direction and a column direction forming an angle of θ(0°<θ<90°) with respect to the row direction, and a plurality of circulation flow channels are arranged in the row direction in such a manner that the plurality of circulation flow channels are respectively provided along nozzle columns formed by the nozzles aligned in the column direction and are connected to the nozzles of the nozzle columns, and
the capping device is configured to simultaneously cap the nozzles which belong to the same nozzle column and are connected to the same circulation flow channel.

6. The liquid ejection apparatus as defined in claim 5, wherein the inkjet head is configured in such a manner that the supply flow channels and the circulation flow channels are alternately arranged between the nozzle columns that are adjacent to each other in the row direction.

7. The liquid ejection apparatus as defined in claim 1, wherein the capping device includes a plurality of modules which each are shorter than a length of the inkjet head in a lengthwise direction and which are joined together so as to have a length corresponding to the length of the inkjet head in the lengthwise direction,
wherein the liquid ejection apparatus further comprises:
a connection switching device which selectively switches connection between each of the plurality of modules and the pressure application device; and
a switching control device which controls the connection switching device so as to successively switch the connection switching device to perform processing of repeating the pressurization and the depressurization of the whole inkjet head.

8. The liquid ejection apparatus as defined in claim 1, further comprising an ejection abnormality determination device which determines presence or absence of an ejection abnormality in the plurality of nozzles,
wherein the capping device simultaneously caps the nozzles including a nozzle determined to have the ejection abnormality by the ejection abnormality determination device.

9. The liquid ejection apparatus as defined in claim 1, further comprising an expulsion device which expels the liquid from the nozzles after processing for repeating pressurization and depressurization is performed by the pressure application device.

10. The liquid ejection apparatus as defined in claim 1, wherein:
the plurality of nozzles are arranged two-dimensionally in a row direction and a column direction forming an angle of θ(0°<θ<90°) with respect to the row direction in such a manner that nozzle columns each formed by the nozzles aligned in the column direction are arranged in the row direction, and
the capping device has a length in the column direction corresponding to the nozzle columns so as to simultaneously cap the nozzles forming one or more nozzle columns.

11. The liquid ejection apparatus as defined in claim 1, wherein:
the plurality of nozzles are arranged two-dimensionally in a row direction and a column direction forming an angle of θ(0°<θ<90°) with respect to the row direction in such a manner that nozzle columns each formed by the nozzles aligned in the column direction are arranged in the row direction, and
the capping device has a length in the row direction corresponding to the nozzles aligned in the row direction so as to simultaneously cap the nozzles aligned in the row direction.

12. The liquid ejection apparatus as defined in claim 1, wherein:
the inkjet heads includes a plurality of head modules joined together, and
the capping device simultaneously caps the nozzles with respect to each of the plurality of head modules.

13. The liquid ejection apparatus as defined in claim 12, wherein:
each of the plurality of head modules has a plurality of nozzle regions to which the nozzles included in each of the plurality of head modules are assigned,
the capping device includes a plurality of capping modules corresponding to the plurality of nozzle regions respectively, and
the liquid ejection apparatus further comprises a connection switching device which selectively switches connection between each of the plurality of capping modules and the pressure application device, and a switching control device which controls the connection switching device.

14. The liquid ejection apparatus as defined in claim 1, further comprising an ink tank connected to the inkjet head and the capping device in such a manner that the liquid is supplied to the inkjet head from the ink tank and is returned to the ink tank via the capping device.

15. The liquid ejection apparatus as defined in claim 14, wherein the inkjet head and the capping device are connected to the ink tank via a switching valve that switches between connection from the ink tank to the inkjet head and connection from the capping device to the ink tank.

16. A head maintenance method for an inkjet head includes a plurality of nozzles which eject liquid containing a water-soluble high-boiling-point organic solvent having an SP value of 30 or lower at a concentration of 10 weight percent or higher and 25 weight percent or lower, a plurality of liquid chambers connected to the plurality of nozzles respectively, and a plurality of supply flow channels which supply the liquid to the plurality of nozzles via the plurality of liquid chambers and to any of which each of the plurality of nozzles is connected,
the head maintenance method comprising:
a capping step of simultaneously capping the nozzles connected to the same supply flow channel from a liquid ejection surface side of the inkjet head; and
a pressurization and depressurization step of repeating pressurization and depressurization of the liquid inside the nozzles via a capping device.

17. The head maintenance method as defined in claim 16, further comprising an expulsion step of expelling the liquid from the nozzles after the pressurization and depressurization step.

18. The head maintenance method as defined in claim 16, further comprising:
an ejection abnormality determination step of determining whether or not an ejection abnormality has occurred in any of the plurality of nozzles;
a first restoration processing step of, when it is determined in the ejection abnormality determination step that the ejection abnormality has occurred in any of the plurality of nozzles, carrying out restoration processing on the nozzle where the ejection abnormality has occurred; and
a second restoration processing step of, when further restoration processing is required for the nozzle after the first restoration processing step, carrying out the capping step and the pressurization and depressurization step.
